(19) United States
(12) Patent Application Publication
(10) Pub. No.: US 2022/0414420 A1
(43) Pub. Date: Dec. 29, 2022

(54) ULTRA-LOW-POWER AND LOW-AREA SOLUTION OF BINARY MULTIPLY-ACCUMULATE SYSTEM AND METHOD

(71) Applicants: STMICROELECTRONICS S.r.l., Agrate Brianza (IT); STMicroelectronics International N.V., Geneva (CH)

(72) Inventors: Loris LUISE, Ornago (IT); Surinder Pal SINGH, NOIDA (IN); Fabio Giuseppe DE AMBROGGI, Biassono (IT)

(73) Assignees: STMICROELECTRONICS S.r.l., Agrate Brianza (IT); STMicroelectronics International N.V., Geneva (CH)

(21) Appl. No.: 17/360,986

(22) Filed: Jun. 28, 2021

(51) Int. Cl. G06N 3/04; G06F 9/30; G06F 7/57

(52) U.S. Cl. CPC G06N 3/04; G06F 9/30014; G06F 7/57; G06F 9/30101

(57) ABSTRACT

Data structure and microcontroller architecture performing binary multiply-accumulate operations using multiple partial copies of weights. Destination-register location, source-register location, and weight-register location are received. Using the weight-register location, a sub-set of the weight bits is copied a select number of times based on a filter index value that is received. Each copy of the sub-set of weights is executed in parallel. Using the source-register location, a sub-set of the input bits is selected based on the size of the sub-set of weights, wherein the sub-set of input bits is shifted one bit from a previous sub-set of input bits. XOR operation is performed on each corresponding bit in the copy of the sub-set of weights with each corresponding bit in the selected sub-set of input bits. In a corresponding destination sub-location, output of each XOR operation is aggregated with each other and with current value of the corresponding destination sub-location.

### BACKGROUND

### Technical Field

The present disclosure generally relates to electronic devices of the type often used in embedded applications. More particularly, but not exclusively, the present disclosure relates to utilizing multiple partial copies of weights to perform binary multiply-accumulate operations for deep neural networks.

### Description of the Related Art

Many computer vision, speech recognition, and signal processing applications benefit from the use of various types of machine learning and artificial intelligence mechanisms. These mechanisms are arranged to quickly perform many hundreds or thousands of operations, often concurrently. One such mechanism is a deep neural network (DNN). A DNN is a computer-based tool that processes large quantities of data and adaptively “learns” by conflating proximally related features within the data, making broad predictions about the data, and refining the predictions based on reliable conclusions and new conflations. For example, a DNN can learn a variety of characteristics of faces such as edges, curves, angles, dots, color contrasts, bright spots, dark spots, etc. The DNN can use these initially learned characteristics to learn a variety of recognizable features of faces such as eyes, eyebrows, foreheads, hair, noses, mouths, cheeks, etc.; each of which is distinguishable from all of the other features. The DNN can then learn higher order characteristics such as a specific face, race, gender, age, emotional state, etc.

Traditionally, DNNs used floating point values—mostly 32-bit to perform various operations, including convolution. Convolution can be represented as a matrix multiplication operation, which is essentially computing the dot product of each row of matrix A with each column of matrix B. In these types of operations, computing the dot product translates to a Multiply-Accumulate (MAC) operation, which can be quite expensive to implement and generally utilizes many logic gates. Therefore, greater die area and more power consumption is utilized for floating point values and more complex convolution. It is with respect to these and other considerations that the embodiments described herein have been made.

### BRIEF SUMMARY

A method may be summarized as including receiving a destination-register location configured to store accumulation results, wherein the destination-register location includes a plurality of destination sub-locations; receiving a source-register location configured to store a plurality of input bits; receiving a weight-register location configured to store a plurality of weight bits, wherein a weight length of the plurality of weight bits is equal to an input length of the plurality of input bits; copying, using the weight-register location, a sub-set of the plurality of weight bits a select plurality of number of times, wherein a size of the sub-set of weights is based on a filter index value; and for each copy of the sub-set of weights: selecting, using the source-register location, a sub-set of the plurality of input bits based on the size of the sub-set of weights, wherein the sub-set of input bits is shifted one bit from a previous sub-set of the plurality of input bits; performing an XOR operation on each corresponding bit in the copy of the sub-set of weights with each corresponding bit in the selected sub-set of input bits; and aggregating, in a corresponding destination sub-location of the plurality of destination sub-locations, an output of each XOR operation with each other and with a current value of the corresponding destination sub-location.

The method may further include receiving the filter index value between 2 and 7. The method may further include receiving the filter index value of zero to indicate a fully connected layer. Copying the sub-set of the plurality of weight bits the select plurality of number of times may include copying the sub-set of the plurality of weight bits five times. The method may further include for each copy of the sub-set of weights: performing a one's count operation on an output from the XOR operations on each corresponding bit in the copy of the sub-set of weights with each corresponding bit in the selected sub-set of input bits.

The method may further include performing an XOR operation on each corresponding remaining bit in the plurality of weights with each corresponding remaining bit in the input bits; performing a one's count operation on an output from the XOR operation on each corresponding remaining bit in the plurality of weights with each corresponding remaining bit in the input bits; and adding the output of the one's count operation with another output from another one's count operation performed on an output from the XOR operation of each corresponding bit in a first copy of the sub-set of weights with each corresponding bit in the a first selected sub-set of input bits.

The method may further include for each copy of the sub-set of weights: performing a one's count operation on an output from the XOR operations on each corresponding bit in the copy of the sub-set of weights with each corresponding bit in the selected sub-set of input bits; generating a filtered output by concatenating outputs from the one's count operations for each copy of the sub-set of weights; performing an XOR operation on each corresponding remaining bit in the plurality of weights with each corresponding remaining bit in the input bits; performing a one's count operation on an output from the XOR operation on each corresponding remaining bit in the plurality of weights with each corresponding remaining bit in the input bits; generating a fully connected output by adding the output of the one's count operation with another output from another one's count operation performed on an output from the XOR operation of each corresponding bit in a first copy of the sub-set of weights with each corresponding bit in the a first selected sub-set of input bits; selecting a final result between the filtered output and the fully connected output based on the filter index value; and combining the final result with a current value stored at the destination-register location.

A system may be summarized as including a memory that stores a destination register configured to store accumulation results, wherein the destination-register includes a plurality of sub-destinations; a source register configured to store a plurality of input bits; a weight register configured to store a plurality of weight bits, wherein a weight length of the plurality of weight bits is equal to an input length of the plurality of input bits; a microprocessor coupled to the memory, wherein the microprocessor, in operation copies a sub-set of the plurality of weight bits in the weight register a select plurality of number of times, wherein a size of the sub-set of weights is based on a filter index value; and for each copy of the sub-set of weights selects a sub-set of the plurality of input bits from the source register based on the size of the sub-set of weights, wherein the sub-set of input bits is shifted one bit from a previous sub-set of the plurality of input bits; performs an XOR operation on each corresponding bit in the copy of the sub-set of weights with each corresponding bit in the selected sub-set of input bits; and aggregates, in a corresponding sub-destination of the plurality of sub-destinations in the destination register, an output of each XOR operation with each other and with a current value of the corresponding sub-destination.

The microprocessor, in further operation, may receive the filter index value between 2 and 7. The microprocessor, in further operation, may receive the filter index value of zero to indicate a fully connected layer. The microprocessor, in further operation, may copy the sub-set of the plurality of weight bits five times. The microprocessor, in further operation, for each copy of the sub-set of weights may perform a one's count operation on an output from the XOR operations on each corresponding bit in the copy of the sub-set of weights with each corresponding bit in the selected sub-set of input bits.

The microprocessor, in further operation, may perform an XOR operation on each corresponding remaining bit in the plurality of weights with each corresponding remaining bit in the input bits; performs a one's count operation on an output from the XOR operation on each corresponding remaining bit in the plurality of weights with each corresponding remaining bit in the input bits; and adds the output of the one's count operation with another output from another one's count operation performed on an output from the XOR operation of each corresponding bit in a first copy of the sub-set of weights with each corresponding bit in the a first selected sub-set of input bits.

The microprocessor, in further operation, for each copy of the sub-set of weights may perform a one's count operation on an output from the XOR operations on each corresponding bit in the copy of the sub-set of weights with each corresponding bit in the selected sub-set of input bits; generates a filtered output by concatenating outputs from the one's count operations for each copy of the sub-set of weights; may perform an XOR operation on each corresponding remaining bit in the plurality of weights with each corresponding remaining bit in the input bits; may perform a one's count operation on an output from the XOR operation on each corresponding remaining bit in the plurality of weights with each corresponding remaining bit in the input bits; may generate a fully connected output by adding the output of the one's count operation with another output from another one's count operation performed on an output from the XOR operation of each corresponding bit in a first copy of the sub-set of weights with each corresponding bit in the a first selected sub-set of input bits; may select a final result between the filtered output and the fully connected output based on the filter index value; and may combine the final result with a current value stored at the destination register.

A non-transitory computer-readable medium having contents that configure a microcontroller to perform a method, the method may be summarized as including receiving a destination-register location configured to store accumulation results, wherein the destination-register location includes a plurality of destination sub-locations; receiving a source-register location configured to store a plurality of input bits; receiving a weight-register location configured to store a plurality of weight bits, wherein a weight length of the plurality of weight bits is equal to an input length of the plurality of input bits; copying, using the weight-register location, a sub-set of the plurality of weight bits a select plurality of number of times, wherein a size of the sub-set of weights is based on a filter index value; and for each copy of the sub-set of weights selecting, using the source-register location, a sub-set of the plurality of input bits based on the size of the sub-set of weights, wherein the sub-set of input bits is shifted one bit from a previous sub-set of the plurality of input bits; performing an XOR operation on each corresponding bit in the copy of the sub-set of weights with each corresponding bit in the selected sub-set of input bits; and aggregating, in a corresponding destination sub-location of the plurality of destination sub-locations, an output of each XOR operation with each other and with a current value of the corresponding destination sub-location. Receiving the filter index value may include receiving the filter index value between 2 and 7. Receiving a filter index value may include receiving the filter index value of zero to indicate a fully connected layer. Copying the sub-set of the plurality of weight bits the select plurality of number of times may include copying the sub-set of the plurality of weight bits five times.

The non-transitory computer-readable medium, may further include for each copy of the sub-set of weights performing a one's count operation on an output from the XOR operations on each corresponding bit in the copy of the sub-set of weights with each corresponding bit in the selected sub-set of input bits. The non-transitory computer-readable medium, may further include performing an XOR operation on each corresponding remaining bit in the plurality of weights with each corresponding remaining bit in the input bits; performing a one's count operation on an output from the XOR operation on each corresponding remaining bit in the plurality of weights with each corresponding remaining bit in the input bits; and adding the output of the one's count operation with another output from another one's count operation performed on an output from the XOR operation of each corresponding bit in a first copy of the sub-set of weights with each corresponding bit in the a first selected sub-set of input bits.

### BRIEF DESCRIPTION OF THE SEVERAL VIEWS OF THE DRAWINGS

Non-limiting and non-exhaustive embodiments are described with reference to the following drawings, wherein like labels refer to like parts throughout the various views, unless the context indicates otherwise. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. One or more embodiments are described hereinafter with reference to the accompanying drawings in which:

FIG. 1 is a block diagram showing an example computing device for implementing embodiments described herein;

FIGS. 2A and 2B are conceptual block diagrams showing example of bit and register structures in accordance with embodiments described herein;

FIGS. 3A and 3B are conceptual block diagrams showing another example of bit and register structures in accordance with embodiments described herein;

FIGS. 4A-4C are conceptual block diagrams showing an example gate architecture in accordance with embodiments described herein;

FIGS. 5A and 5B show a logical flow diagram of a process for performing a new processor instruction to do binary multiply-accumulate operations in accordance with embodiments described herein; and

FIG. 6 shows a logical flow diagram of an alternative process for performing the new processor instruction to do binary multiply-accumulate operations in accordance with embodiments described herein.

### DETAILED DESCRIPTION

In the following description, along with the accompanying drawings, certain details are set forth in order to provide a thorough understanding of various embodiments of devices, systems, methods, and articles. One of skill in the art, however, will understand that other embodiments may be practiced without these details. In other instances, well-known structures and methods associated with, for example, circuits, such as transistors, multipliers, adders, dividers, comparators, integrated circuits, logic gates, finite state machines, accelerometers, gyroscopes, magnetic field sensors, memories, bus systems, etc., have not been shown or described in in detail in some figures to avoid unnecessarily obscuring descriptions of the embodiments. Moreover, well-known structures or components that are associated with the environment of the present disclosure, including but not limited to the communication systems and networks, have not been shown or described in order to avoid unnecessarily obscuring descriptions of the embodiments.

Unless the context requires otherwise, throughout the specification and claims that follow, the word “comprise” and variations thereof, such as “comprising,” and “comprises,” are to be construed in an open, inclusive sense, that is, as “including, but not limited to.”

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive, and allows for being based on additional features, functions, aspects, or limitations not described, unless the context clearly dictates otherwise. In addition, throughout the specification, the meaning of “a,” “an,” and “the” include singular and plural references. Furthermore, the particular features, structures, or characteristics may be combined in any suitable manner in one or more embodiments to obtain further embodiments.

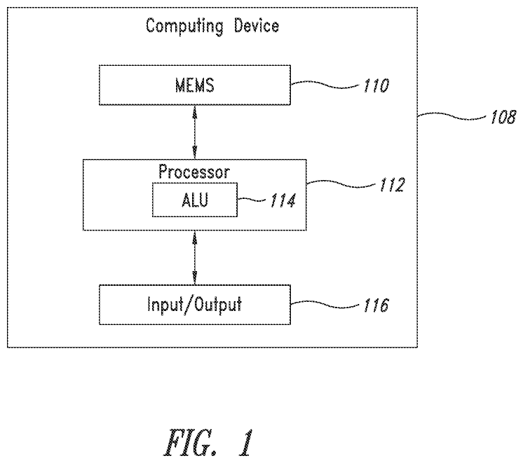

FIG. 1 is a block diagram showing an example computing device 108 for implementing embodiments described herein. Computing device 108 includes a MEMS 110, processor 112, and an input/output 116. Although not illustrated, computing device 108 may have other computing components.

MEMS 110 obtain various sensor data that is provided to processor 112 for processing. MEMS 110 may include accelerometers or gyroscopes configured to sense movement or positional data associated with the computing device 108. Although FIG. 1 shows the use of a MEMS, other sensing technologies or input sensors may also be used. Such other sensors may include, but are not limited to, a GPS system, a temperature sensor, a gas sensor, a pressure sensor, a magnetism sensor, imaging sensors, etc., or various combinations thereof.

Data obtained from MEMS 110 is provided to processor 112 for additional processing. The processor 112 includes one or more processing cores or circuits. The processor may comprise, for example, one or more processors, a state machine, a microprocessor, a programmable logic circuit, discrete circuitry, logic gates, registers, etc., and or various combinations thereof. The processor 112 may control overall operation of the computing device 108, execution of applications programs by the computing device 108, etc.

The processor 112 includes an arithmetic logic unit (ALU) 114. The processor 112, the ALU 114, or some combination thereof, may perform embodiments described herein. Thus, in some embodiments where the processor 112 performs the embodiments described herein, the ALU 114 may not be present in the computing device 108. Conversely, if the ALU 114 performs the embodiments described herein, the computing device 108 may still include the processor 112 to perform other actions associated with the functioning of the computing device 108.

The computing device 108 also includes one or more memories (not shown), such as one or more volatile or non-volatile memories, or a combination thereof, which may store, for example, all or part of instructions and data related to applications and operations performed by the computing device 108. For example, the memory may store computer instructions that when executed by the processor 108 perform the actions described herein. The memory also stores various information, including input data or weights, used to perform embodiments described herein.

The computing device 108 also includes input/output 116. The input/output 116 may be configured to output information or results obtained or determined by processor 112 or ALU 114, such as by performing embodiments described herein. In other embodiments, input/output 116 may be configured to receive input data from other computing devices or external sensors.

The computing device 108 may also include a bus system (not illustrated), which may be configured such that the processor, MEMS 110, input/output 116, memories, or other circuits or circuitry (not illustrated) 108 are communicatively coupled to one another to send or receive, or send and receive, data to or from other components. The bus system may include one or more of data, address, power, or control busses, or some combination thereof, electrically coupled to the various components of the computing device 108.

As described herein, ALU 114 may implement a new processor instruction and data structure to perform binary multiple-accumulate operations in neural network calculations. In various embodiments, this new processor instruction may take the form of:
stxcnt % rd, % rs, % rs0, filter_idx=#imm
   where,

stxcnt is the calling operation for the instruction;

% rd is the destination register location, which keeps the accumulation results;

% rs is the source register location, which keeps 32 continuous input data bits A that may be represented as a[i,31]˜a[i, 0];

% rs0 is the weights register location, which keeps the source operand of weight bits W that may be represented as w[31]˜w[0] contains only one set without duplication; and

filter_idx is used to indicate which filter is implemented (from 2 to 7).

The following is an example demo code of the kernel loop for a two-dimensional 3×3 convolution filter, which utilize the new processor instruction data structure and logic architecture described herein:

| | |
|---|---|
| 1dw %r0, [%r5] | ;load weights (w[31],w[30],w[29],w[28], ...,w[23],0,0...) |
| 1dw %r2, [%r6]+ | ; load first row of input data(a[0,31]~a[0,0]) |
| 1dw %r3, [%r6]+ | ; load second row of input data (a[1,31]~a[1,0]) |
| 1dw %r4, [%r6]+ | ; load third row of input data (a[2,31]~a[2,0]) |

loop_2D:

| | |
|---|---|
| movw %r1, #0 | ; reset accumulators |

stxcnt %r1, %r2, %r0, 3 ; new processor instruction to perform first convolutional part
rd0,

| | |
|---|---|
| | rd1, rd2, rd3, rd4 described herein |
| rotlw %r0, #3 | ; rotate left weights (w[28]~w[23],0,0,0...0,0,w[31]~w[29]) |
| | because first set of weights is used |

stxcnt %r1, %r3 %r0, 3 ; new processor instruction to perform second convolutional
part

| | |
|---|---|
| | rd0+rd0new, rd1+rd1new, rd2+rd2new, rd3+rd3new, |
| | rd4+rd4new described herein because first input row has |
| | been used |
| rotlw %r0, #3 | ; rotate left weights (w[25]~w[23],0,0,0...0,0,w[31]~w[26]) |

stxcnt %r1, %r4, %r0, 3 ; new processor instruction to perform third convolutional
part

| | |
|---|---|
| | rd1+rd1new, rd2+rd2new, rd3+rd3new, rd4+rd4new |
| | described herein because second input row has been used |
| rotrw %r0, #6 | ; rotate right weights (for initial phase) |
| | (w[31]~w[23],0,0,0...) to reset for another loop |
| stw [%r7]+, %r1 | ; store result (r1) from running three new processor |

instructions

| | |
|---|---|
| | 3 consecutive rows in 3x3 2D convolutional filter |
| sllw row1, row2,row3 | ; shift left the input data for the next filters |

jpia loop_2D

These instructions are for illustration purposes and could be different for different computer languages. However, this illustration demonstrates how the new processor instruction, data structure, and architecture described herein can be used to perform a two-dimensional 3×3 convolution filter. Similar embodiments can be used for other sizes of filters, for example, from size 2×2 to 7×7. Other filter sizes may also be considered by using additional bit lines, additional copies of weight bits, etc.

Similar embodiments can be utilized for a fully connected layer. The following is an example demo code of the kernel loop for a fully connected convolution layer, which utilize the new processor instruction data structure and logic architecture described herein:

| | |
|---|---|
| movw %r1, #0 | ; reset accumulator |

loop_FC:

| | |
|---|---|
| 1dw %r0, [%r5]+ | ; load weights (w[31]~w[0]) |
| 1dw %r2, [%r6]+ | ; load row of input data (a[0,31]~a[0,0]) |

stxcnt %r1, %r2, %r0, 0 ; 0 new processor instruction to perform fully connected
layer

| | |
|---|---|
| cmp end_fiter | ; compare the cycle loop |

jpdne loop_FC

| | |
|---|---|
| stw [%r7]+, %r1 | ; store result (r1) of the fully connected layer |

These instructions are for illustration purposes and could be different for different computer languages. However, this illustration demonstrates how the new processor instruction, data structure, and architecture described herein can be used to perform a fully connected convolution layer.

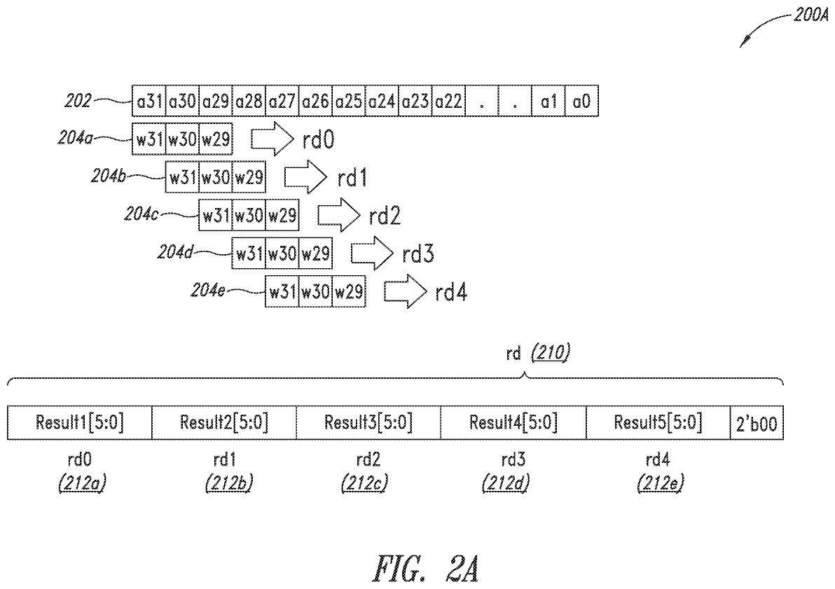

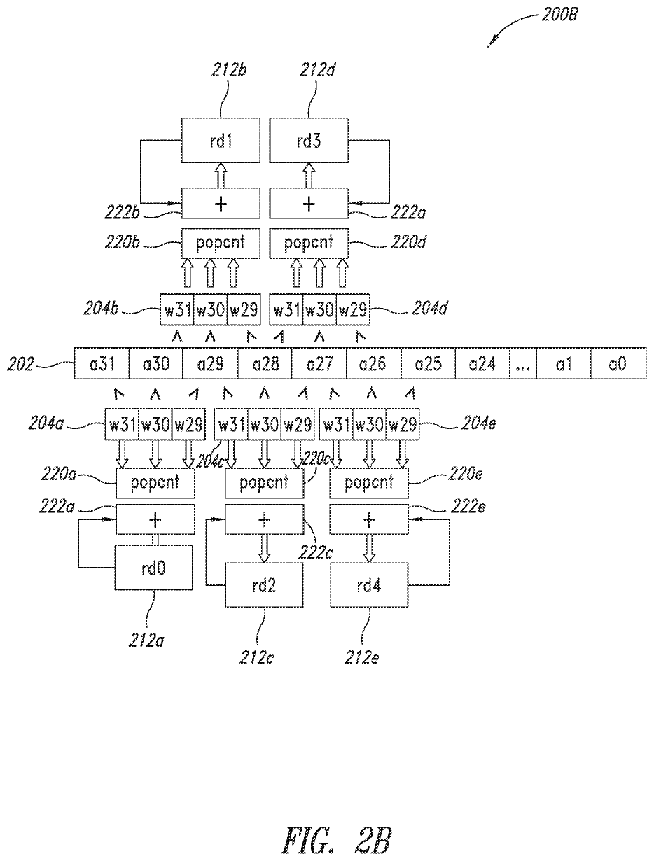

FIGS. 2A and 2B are conceptual block diagrams showing example of bit and register structures in accordance with embodiments described herein. Convolution bit structure 200A in FIG. 2A illustrates a plurality of input bits 202 and multiple copies of weight bits 204a-204e. The input bits 202 are obtained from an input register (not shown). In this example, the input bits 202 include 32 bits.

The number of copies of weight bits 204a-204e is selected by an administrator or developer. In this example, there are five copies of weight bits 204a-204e. Each copy of the weight bits 204a-204e is a sub-set of weight bits obtained from a weight register (not illustrated). The number of bits in each copy of weight bits 204a-204e is selected based on a filter input value that selects the size or type of filter to be employed. In this example, the filter input value is three, and thus each copy of weight bits 204a-204e includes the same three bits obtained from the weight register.

Each copy of weight bits 204a-204e is arranged to correspond to a separate sub-set of input bits 202. For example, weight bits 204a correspond to input bits a31, a30, and a29; weight bits 204b correspond to input bits a30, a29, and a28; weight bits 204c correspond to input bits a29, a28, and a27; weight bits 204d correspond to input bits a28, a27, and a26; and weight bits 204e correspond to input bits a27, a26, and a25.

Each copy of weight bits 204a-204e corresponds to a separate destination sub-location 212a-212e (also referred to as destination sub-register) within destination register 210. For example, copy of weight bits 204a corresponds to destination sub-location 212a, copy of weight bits 204b corresponds to destination sub-location 212b, copy of weight bits 204c corresponds to destination sub-location 212c, copy of weight bits 204d corresponds to destination sub-location 212d, and copy of weight bits 204e corresponds to destination sub-location 212e.

As described in more detail below, when the weight bits 204a-204e are XOR'd with corresponding input bits 202 and aggregated together, the aggregate is combined with a current result or value stored in the corresponding destination sub-location 212a-212e. The resulting combination is then re-stored in the corresponding destination sub-location 212a-212e.

FIG. 2B is a further conceptual block diagram of the bit and register structure discussed above in FIG. 2A. Block structure 200B includes input bits 202 and multiple copies of weight bits 204a-204e. Structure 200 also includes popcount 220a-220e, summation 222a-222e, and destination sub-locations 212a-212e.

With respect to copy of weight bits 204a, weight bit w31 is XOR'd with input bit a31, weight bit w30 is XOR'd with input bit a30, and weight bit w29 is XOR'd with input bit a29. The results of these XOR operations is provided to popcount 220a, where the number of 1's bits from the XOR operations is calculated. The results from popcount 220a are provided to summation 222a, which is combined with a current value stored in destination sub-location 212a. The output from summation 222a is written to destination sub-location 212a.

Embodiments for copies of weight bits 204b-204e are similarly employed but for shifted input bits. Details of each are provided for completeness.

With respect to copy of weight bits 204b, weight bit w31 is XOR'd with input bit a30, weight bit w30 is XOR'd with input bit a29, and weight bit w29 is XOR'd with input bit a28. The results of these XOR operations is provided to popcount 220b, where the number of 1's bits from the XOR operations is calculated. The result from popcount 220b is provided to summation 222b, which is combined with a current value stored in destination sub-location 212b. The output from summation 222b is written to destination sub-location 212b.

With respect to copy of weight bits 204c, weight bit w31 is XOR'd with input bit a29, weight bit w30 is XOR'd with input bit a28, and weight bit w29 is XOR'd with input bit a27. The results of these XOR operations is provided to popcount 220c, where the number of 1's bits from the XOR operations is calculated. The result from popcount 220c is provided to summation 222c, which is combined with a current value stored in destination sub-location 212c. The output from summation 222c is written to destination sub-location 212c.

With respect to copy of weight bits 204d, weight bit w31 is XOR'd with input bit a28, weight bit w30 is XOR'd with input bit a27, and weight bit w29 is XOR'd with input bit a26. The results of these XOR operations is provided to popcount 220d, where the number of 1's bits from the XOR operations is calculated. The results from popcount 220d are provided to summation 222d, which is combined with a current value stored in destination sub-location 212d. The output from summation 222d is written to destination sub-location 212d.

With respect to copy of weight bits 204e, weight bit w31 is XOR'd with input bit a27, weight bit w30 is XOR'd with input bit a26, and weight bit w29 is XOR'd with input bit a25. The results of these XOR operations is provided to popcount 220e, where the number of 1's bits from the XOR operations is calculated. The results from popcount 220e are provided to summation 222e, which is combined with a current value stored in destination sub-location 212e. The output from summation 222e is written to destination sub-location 212e.

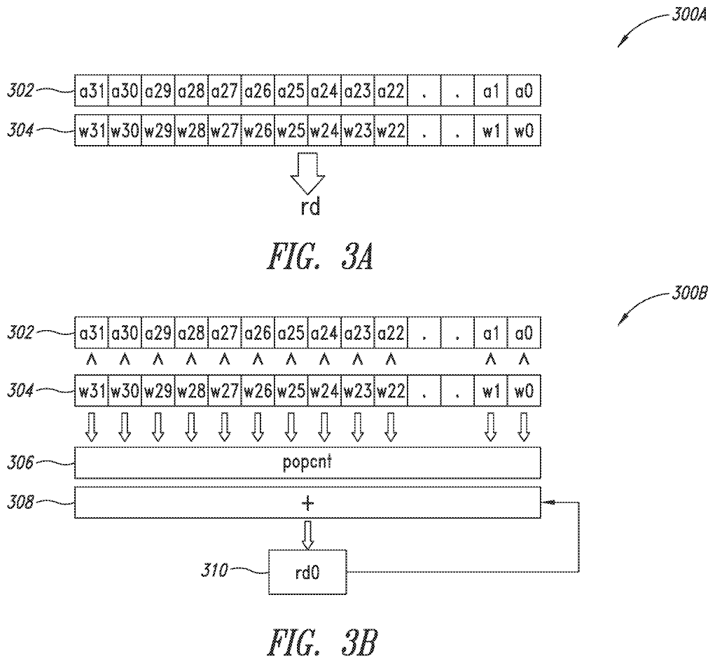

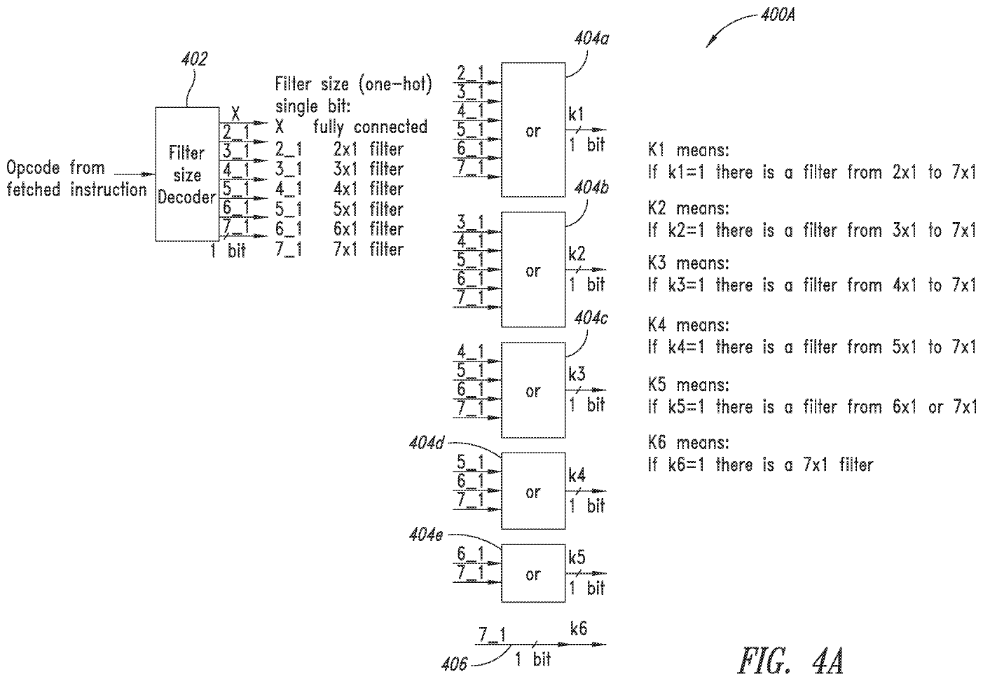

FIGS. 3A and 3B are conceptual block diagrams showing another example of bit and register structures in accordance with embodiments described herein. Convolution bit structure 300A in FIG. 3A illustrates a plurality of input bits 302 and a plurality of weight bits 304. In various embodiments, this bit structure is utilized when the filter input value is zero indicating a fully connected convolution layer.

The input bits 302 are obtained from an input register (not shown). In this example, the input bits 302 include 32 bits. The weight bits 304 are obtained from a weight register (not shown). In this example, the weight bits 304 include 32 bits. Each weight bit 304 corresponds to an input bit 302. For example, weight bit w31 corresponds to input bit a31, weight bit w30 corresponds to input bit a30, and so on.

FIG. 3B is a further conceptual block diagram of the bit and register structure discussed above in FIG. 3A. Block structure 300B includes input bits 302, weight bits 304, popcount 306, summation 308, and destination sub-location 310.

Each corresponding weight bit 304 is XOR'd with a corresponding input bit 302. For example, weight bit w31 is XOR'd with input bit a31, weight bit w30 is XOR'd with input bit a30, weight bit w29 is XOR'd with input bit a29, weight bit w28 is XOR'd with input bit a28, and so on. The results of these XOR operations is provided to popcount 306, where the number of 1's bits from the XOR operations is calculated. The results from popcount 306 are provided to summation 308, which is combined with a current value stored in destination sub-location 310. The output from summation 308 is written to destination sub-location 310. In some embodiments, destination sub-location 310 uses the same memory as destination sub-location 212a in FIG. 2A.

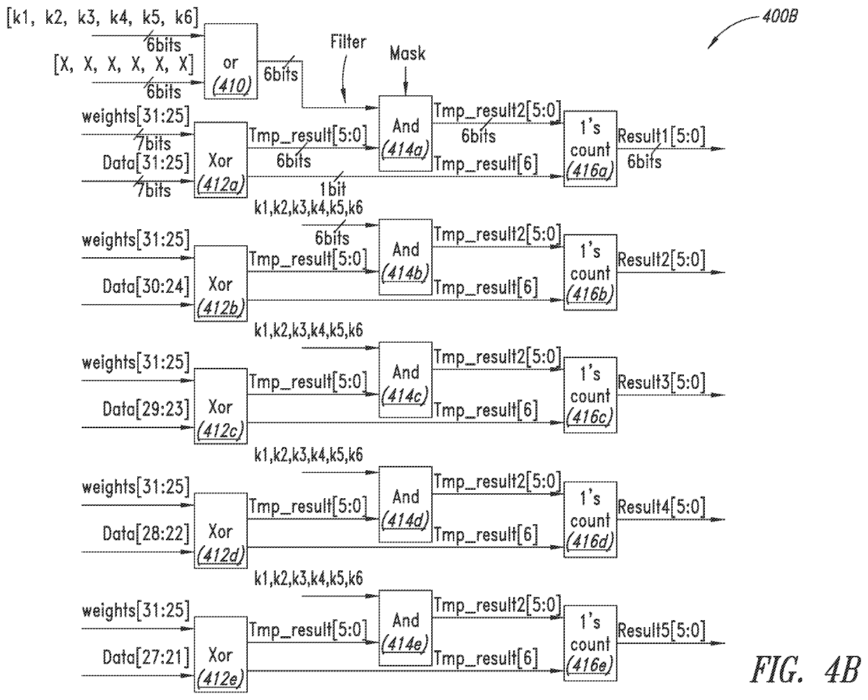

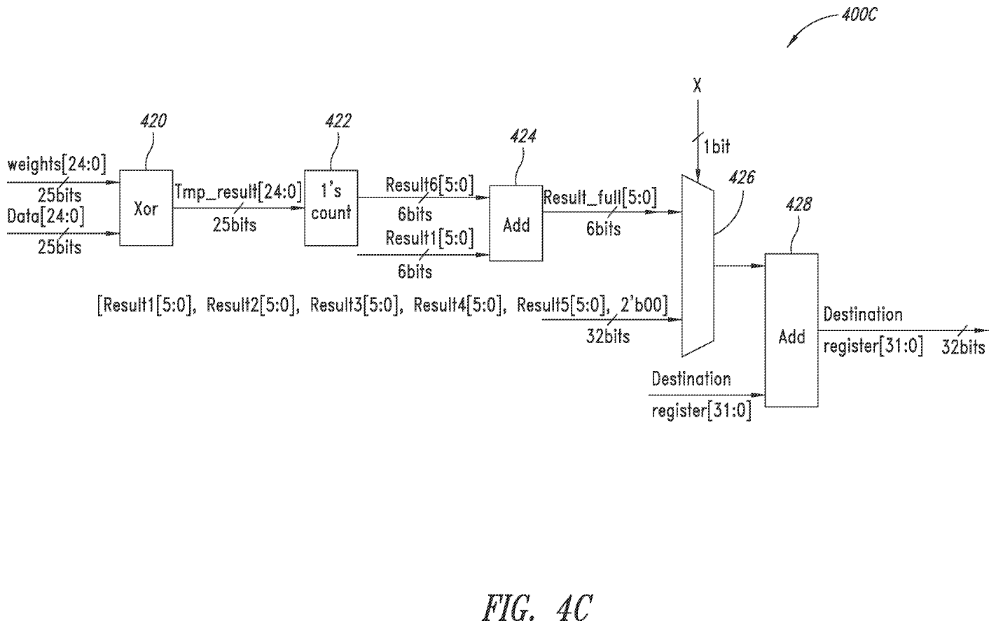

FIGS. 4A-4C are conceptual block diagrams showing an example architecture in accordance with embodiments described herein. Architecture 400A in FIG. 4A includes a filter size decoder 402 and ORs 404a-404e. The opcode from the fetched new processor instruction described herein is input into filter size decoder 402. In some embodiments, this input may be a separate input associated with the new processor instruction. Each output from filter size decoder is a single separate bit. Each separate output line or output bit represents a different filter size, where output line 2_1 represents a 2×1 filter, output line 3_1 represents a 3×1 filter, output line 4_1 represents a 4×1 filter, output line 5_1 represents a 5×1 filter, output line 6_1 represents a 6×1 filter, output line 7_1 represents a 7×1 filter, and output line X represents a fully connected layer.

The output lines from filter size decoder 402 are input into ORs 404a-404e. In particular, output line 2_1 is input into OR 404a; output line 3_1 is input into OR 404a-404b; output line 4_1 is input into OR 404a-404c; output line 5_1 is input into OR 404a-404d; output line 6_1 is input into OR 404a-404e; and output line 7_1 is input into OR 404a-404e. Output line 7_1 is also a separate line 406.

If the output, labeled k1, from OR 404a is “1,” then the filter is a size from 2×1 to 7×1. If the output, labeled k2, from OR 404b is “1,” then the filter is a size from 3×1 to 7×1. If the output, labeled k3, from OR 404c is “1,” then the filter is a size from 4'1 to 7×1. If the output, labeled k4, from OR 404d is “1,” then the filter is a size from 5×1 to 7×1. If the output, labeled k5, from OR 404e is “1,” then the filter is a size from 6×1 to 7×1. If line 406, labeled k6, is “1,” then the filter is a size of 7×1.

Architecture 400B in FIG. 4B includes OR 410, XOR 412a-412e, AND 414a, and one's count 416a-416e. The outputs from OR 404a-404e and line 406 in FIG. 4A are provided as a 6 bit input to OR 410 in FIG. 4B. Likewise, the output line X from OR 402 in FIG. 4A is provided as a 6 bit input into OR 410. OR 410 performs a logical OR on the inputs and outputs a six bit result. This result identifies the convolution filter to be applied. Accordingly, the result from OR 410 is provided as input to each of AND 414a-414e.

Each XOR 412a-412e has two seven bit inputs, one seven bit weight input and one seven bit data input. Seven bits are used for each input because the filter size ranges from 2×1 to 7×1. The actual number of active bit lines would vary depending on the filter input value provided with the new processor instruction. The seven bit weight input is a copy of weight bits [31:25] from the 32 bit weight register described herein. The seven bit data input is obtained from the 32 bit data input register described herein, but each input is shifted one bit. For example, the inputs to XOR 412a include weights [31:25] and data [31:25]; the inputs to XOR 412b include weights [31:25] and data [30:24]; the inputs to XOR 412c include weights [31:25] and data [29:23]; the inputs to XOR 412d include weights [31:25] and data [28:22]; and the inputs to XOR 412e include weights [31:25] and data [27:21].

Each XOR 412a-412e performs a logical exclusive OR operation on the two inputs. The corresponding first six bits output (shown as Tmp_results[5:0]) from the corresponding XOR 412a-412e are provided to corresponding AND 414a-414e. The corresponding seventh bit output (shown as Tmp_result[6]) from the corresponding XOR 412a-412e are provided to corresponding one's count 416a-416e.

Each AND 414a-414e performs a logical AND operation on the corresponding six bit input (Tmp_results[5:0]) and the six bit filter output from OR 410. The corresponding results (shown as Tmp_results2[5:0]) from corresponding AND 414a-414e are provided to corresponding one's count 416a-416e.

Each one's count 416a-416e performs operations to count the number of ones bits between the results (Tmp_results2[5:0]) from corresponding AND 414a-414b and the seventh bit output (Tmp_result[6]) from corresponding XOR 412a-412e. The output of one's count 416a is shown as Result1[5:0]; the output of one's count 416b is shown as Result2[5:0]; the output of one's count 416c is shown as Result3[5:0]; the output of one's count 416d is shown as Result4[5:0]; and the output of one's count 416e is shown as Result5 [5:0].

Architecture 400C in FIG. 4C includes XOR 420, one's count 422, adder 424, MUX 426 and adder 428. In general, the MUX 426 selects between using the outputs from filters 2×1 to 7×1 in FIG. 4B or a fully connected layer.

XOR 420 has two 25 bit inputs, weights[24:0] and data[24:0]. Weights[24:0] are the remaining weight bits in the weight register that are not used in FIG. 4B, and data[24:0] are obtained from the input register that also provided the data input bits used in FIG. 4B. XOR 420 performs a logical exclusive OR operation on the inputs and outputs a 25 bit result (shown as Tmp_result[24:0]). The output from XOR 420 is provided to one's count 422, where a total number of ones bits are counted. The output from one's count 422 is a six bit output (shown as Result6[5:0]) that is provided to adder 424.

Adder 424 adds the result (Result6[5:0]) from one's count 422 with the output (Result1[5:0]) from one's count 416a in FIG. 4B. This addition calculates the total result of a fully connected layer because Result1[5:0] is obtained from data input[31:25] and Result6[5:0] is obtained from data input[24:0], thus using all bits from the 32 bit input register.

The output from adder 424 is shown as Result full[5:0] and is provided as input to MUX 426. The combined results from one's count 416a-416e in FIG. 4B are provided as a 32 bit input into MUX 426 in FIG. 4C. MUX 426 also includes a one bit control line, whose input is the X output line from filer size decoder 402 in FIG. 4A. MUX 426 selects between using the results from a fully connected layer or the results from a filter between 2×1 to 7×1.

The output from MUX 426 is provided to adder 428. Adder 428 adds the result from MUX 426 with the current destination register value (shown as destination register[31:0]). The output from adder 428 is then written to the destination register. Therefore, in a non-fully connected layer, the outputs of each separate one's count 416a-416d in FIG. 4B are stored in the corresponding sub-locations of the destination register, without having to make multiple calls or writes to the destination register.

The components shown in FIGS. 4A-4C may include or be made up of one or more logical gates.

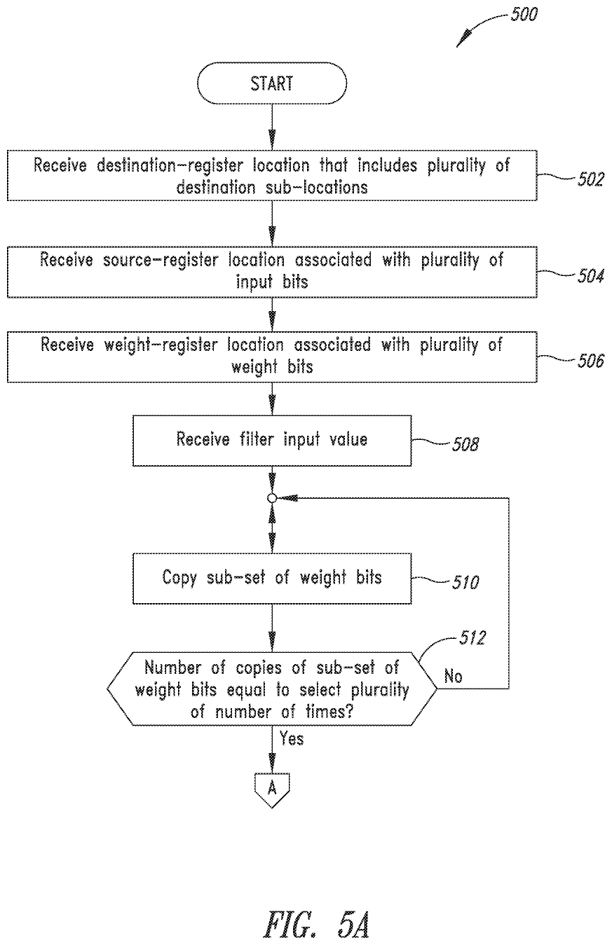

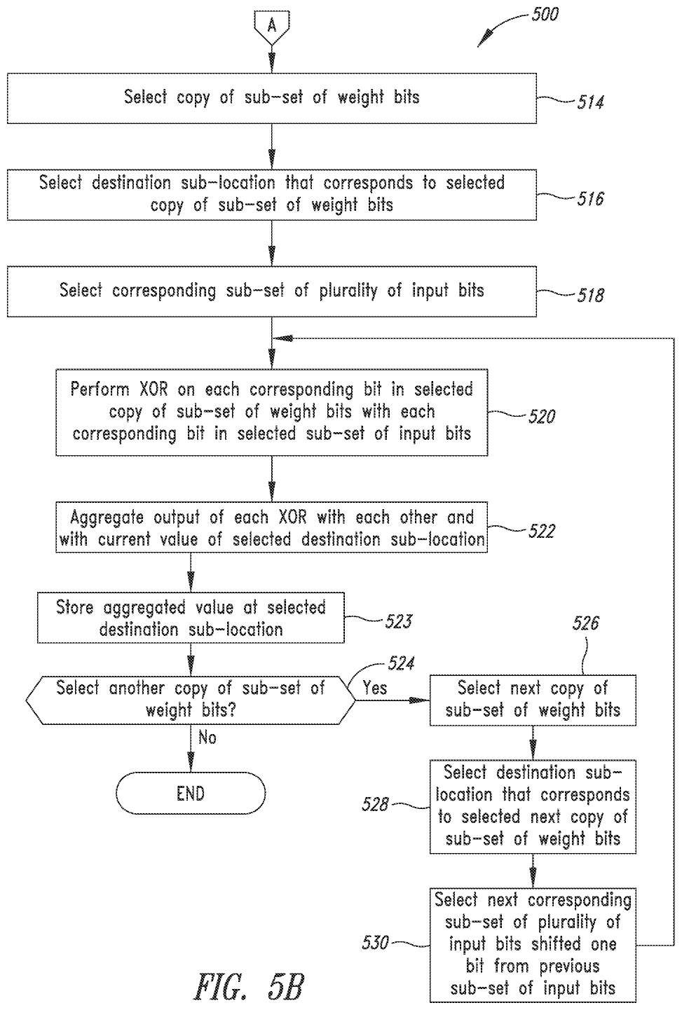

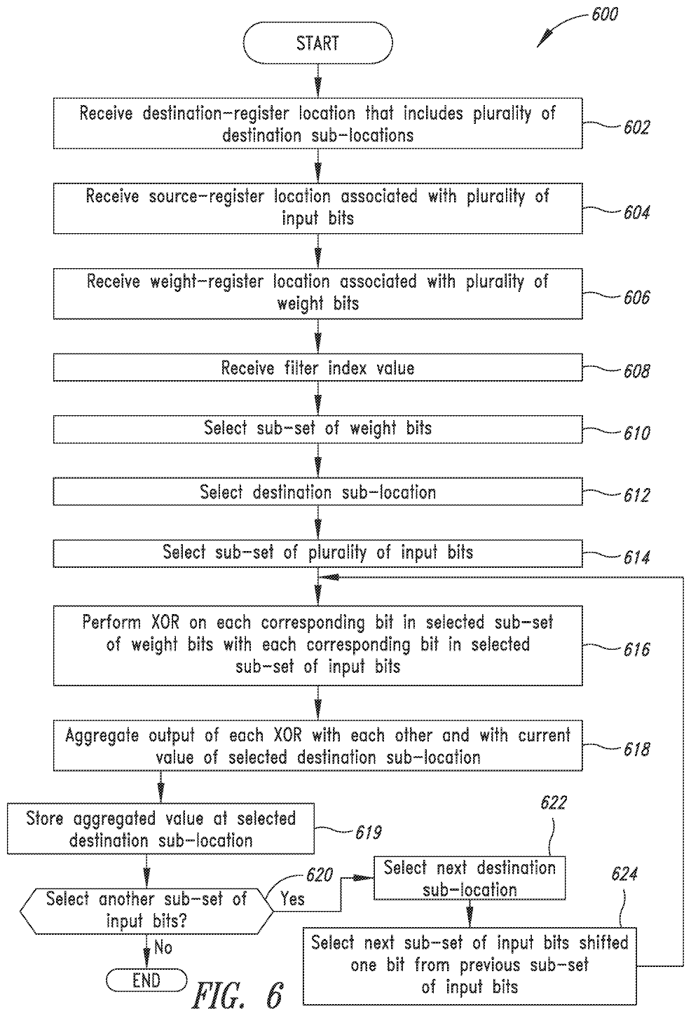

The operation of one or more embodiments will now be described with respect to FIGS. 5A, 5B and 6, and for convenience will be described with respect to the embodiments of FIGS. 1-4 described above. In at least one of various embodiments, processes 500 and 600 described in conjunction with FIGS. 5A-5B and 6, respectively, may be implemented by or executed on one or more computing devices, such as computing device 108 in FIG. 1.

FIGS. 5A and 5B show a logical flow diagram of a process 500 for performing a new processor instruction to do binary multiply-accumulate operations in accordance with embodiments described herein. Process 500 begins, after a start block, at block 502, where a destination-register location is received. The destination-register location identifies a memory location of a destination register. In various embodiments, the destination register stores 32 bits in memory. The destination register is logically separated into a plurality of destination sub-locations. In at least one embodiment, the destination register is separated into at least five sub-locations. These destination register sub-locations are utilized as accumulators.

Process 500 proceeds to block 504, where a source-register location is received. The source-register location identifies the memory location of a source register that includes a plurality of input bits. In at least one embodiment, the source register stores 32 bits in memory. In some embodiments, the source register is loaded with input data received from another process or sensor. For example, the input data may be a portion of an image that is being analyzed using a DNN.

Process 500 continues at block 506, where a weight-register location is received. The weight-register location identifies the memory location of a weight register that includes a plurality of weight bits. In at least one embodiment, the weight register stores 32 bits in memory. In some embodiments, the weight register is loaded with weights for processing the input data. In at least one embodiment, the weights may be selected for employment during convolution of a DNN.

Process 500 proceeds next to block 508, where a filter input value is received. In various embodiments, the filter input value identifies the type or size of filters to be employed during convolution of the DNN.

Process 500 continues next at block 510, where a sub-set of the weight bits in the weight register are copied. In some embodiments, the size of the copied sub-set is equal to the filter input value. In other embodiments, the size of the copied sub-set is equal to the maximum number of weight bits when then filter input value is zero, such as in during processing of a fully connected convolution layer. In at least one embodiment, the sub-set of weight bits is selected from the highest ordered bits in the weight bits.

Process 500 proceeds to decision block 512, where a determination is made whether the number of copies of the sub-set of weight bits equals a select plurality of number of times. In at least one embodiment, the selected plurality of number of times is five. Although embodiments described herein discuss copying the sub-set of weight bits five times, other numbers of times may also be used. The number of copies may be selected based on the number of bits in the source register, the filter input value, or other factors. If the number of copies of the sub-set of weight bits equals the selected plurality of number of times, then process 500 flows to block 514 in FIG. 5B; otherwise, process 500 loops to block 510 in FIG. 5A to make another copy of the sub-set of weight bits.

At block 514 in FIG. 5B, a copy of the sub-set of weight bits is selected.

Process 500 proceeds to block 516, where a destination sub-location of the plurality of destination sub-locations is selected. This selected destination sub-location corresponds to the selected copy of the sub-set of weight bits. For example, a first destination sub-location may be selected for a first copy.

Process 500 continues at block 518, where a corresponding sub-set of the plurality of input bits is selected for the selected copy of the sub-set of weight bits. For example, a first sub-set of input bits may be selected for a first copy of the sub-set of weight bits. In various embodiments, the number of bits in the sub-set of input bits is equal to the number of bits in the copy of the sub-set of weight bits.

Process 500 proceeds next to block 520, where an XOR (exclusive “OR”) operation is performed on each corresponding bit in the selected copy of sub-set of weight bits with each corresponding bit in the selected sub-set of input bits. For example, if the selected sub-set of input bits includes three bits: a31, a30, and a29, and if the selected sub-set of weight bits includes three bits: w31, w30, and w29, then the following corresponding bit XOR operations are performed: a31 XOR w31, a30 XOR w30, and a29 XOR w29.

Process 500 continues next at block 522, where the output of each XOR operation in block 520 is aggregated with each other and with a current value stored in the selected destination sub-location. For example, if the output of a31 XOR w31 is 1, the output of a30 XOR w30 is 0, and the output of a29 XOR w29 is 1, then the aggregated XOR output value is 2. If the currently stored value in the selected destination sub-location is 3, then the total aggregated value is 5.

Process 500 proceeds to block 523, where the total aggregated value is stored in the destination registration at the selected destination sub-location. In this way, the previously stored value in the selected destination sub-location is written over with the new total aggregated value.

Process 500 continues at decision block 524, where a determination is made whether to select another copy of the sub-set of weight bits. In various embodiments, the determination to select another copy of the sub-set of weight bits will continue until all copies have been selected. If another copy of the sub-set of weight bits is to be selected, process 500 flows to block 526; otherwise, process 500 terminates or otherwise returns to a calling process to perform other actions.

At block 526, a next copy of the sub-set of weight bits is selected. In various embodiments, block 526 may include embodiments of block 514, but to select another, non-processed copy of subset of weight bits.

Process 500 proceeds next to block 528, where a destination sub-location that corresponds to the selected next copy of sub-set of weight bits is selected. For example, a second destination sub-location may be selected for a second copy. In various embodiments, block 528 may include embodiments of block 516.

Process 500 continues next to block 530, where a next corresponding sub-set of the plurality of input bits is selected for the selected next copy of sub-set of weight bits. The selected next sub-set of input bits are selected by shifting the sub-set one bit, such as one bit to the right, from the previously selected sub-set of input bits. For example, if the input bits include a31, a30, a29, a28, a27, . . . , a0, and the previously selected sub-set of input bits includes a31, a30, and a29, then the next selected sub-set of input bits includes a30, a29, and a28.

After block 530, process 500 loops to block 520 where an XOR operation is performed on each corresponding bit in the selected next copy of the sub-set of weight bits with each corresponding bit in the selected next sub-set of input bits.

Although process 500 is described as looping through the copies of the sub-set of weight bits, embodiments are not so limited. In various embodiments, separate copies of the sub-set of weight bits are utilized in parallel. Thus, the performance of blocks, 514, 516, 518, 520, 522, and 523 for a first copy of the sub-set of weight bits, a first sub-set of input bits, and a first destination sub-location may be in parallel to the performance of blocks, 514, 516, 518, 520, 522, and 523 for a second copy of the sub-set of weight bits, a second sub-set of input bits, and a second destination sub-location. In this way, multiple sub-set of input values are processed in parallel. In at least one embodiment, these parallel operations are being performed for five sub-sets of input values using five copies of the sub-set of weight bits, along with five corresponding destination sub-locations.

FIG. 6 shows a logical flow diagram of an alternative process 600 for performing the new processor instruction to do binary multiply-accumulate operations in accordance with embodiments described herein.

Process 600 begins, after a start block, at block 602, where a destination-register location is received. In various embodiments, block 602 may perform embodiments similar to block 502 in FIG. 5A.

Process 600 proceeds to block 604, where a source-register location is received. In various embodiments, block 604 may perform embodiments similar to block 504 in FIG. 5A.

Process 600 proceeds to block 606, where a weight-register location is received. In various embodiments, block 606 may perform embodiments similar to block 506 in FIG. 5A.

Process 600 proceeds to block 608, where a filter index value is received. In various embodiments, block 608 may perform embodiments similar to block 508 in FIG. 5A.

Process 600 continues next at block 610, where a sub-set of the weight bits in the weight register is selected. In some embodiments, the size of the sub-set is equal to the filter input value. In other embodiments, the size of the sub-set is equal to the maximum number of weight bits when then filter input value is zero, such as in during processing of a fully connected convolution layer. In at least one embodiment, the sub-set of weight bits is selected from the highest ordered bits in the weight bits.

Process 600 proceeds to block 612, where a destination sub-location of the plurality of destination sub-locations is selected. This selected destination sub-location corresponds to the selected sub-set of weight bits. For example, a first destination sub-location may be selected for a first selected sub-set of weight bits.

Process 600 continues at block 614, where a corresponding sub-set of the plurality of input bits is selected for the selected sub-set of weight bits. In various embodiments, the number of bits in the sub-set of input bits is equal to the number of bits in the selected sub-set of weight bits.

Process 600 proceeds next to block 616, where an XOR (exclusive “OR”) operation is performed on each corresponding bit in the selected of sub-set of weight bits with each corresponding bit in the selected sub-set of input bits. In various embodiments, block 616 may perform embodiments similar to block 520 in FIG. 5B.

Process 600 continues next at block 618, where the output of each XOR operation in block 616 is aggregated with each other and with a current value stored in the selected destination sub-location. In various embodiments, block 618 may perform embodiments similar to block 522 in FIG. 5B.

Process 600 proceeds to block 619, where the total aggregated value is stored in the destination registration at the selected destination sub-location. In various embodiments, block 619 may perform embodiments similar to block 523 in FIG. 5B.

Process 600 continues at decision block 620, where a determination is made whether to select another sub-set of input bits. In various embodiments, the determination to select another sub-set of input bits is performed until a select number of sub-sets have been selected. If another sub-set of input bits is to be selected, process 600 flows to block 622; otherwise, process 600 terminates or otherwise returns to a calling process to perform other actions.

At block 622, a next destination sub-location is selected. For example, a second destination sub-location may be selected for a second sub-set of input bits. In various embodiments, block 622 may include embodiments of block 612.

Process 600 continues next to block 624, where a next corresponding sub-set of the plurality of input bits is selected. The selected next sub-set of input bits are selected by shifting the sub-set one bit, such as one bit to the right, from the previously selected sub-set of input bits. In various embodiments, block 624 may include embodiments of block 530 in FIG. 5B.

After block 624, process 600 loops to block 616 where an XOR operation is performed on each corresponding bit in the selected sub-set of weight bits with each corresponding bit in the selected next sub-set of input bits.

Although process 600 is described as looping through separate sub-sets of input bits, embodiments are not so limited. In various embodiments, separate sub-sets of input bits are processed in parallel. Thus, the performance of blocks, 612, 614, 616, 618, and 619 for a first sub-set of input bits, a first destination sub-location, and the selected sub-set of weight bits may be in parallel to the performance of blocks, 612, 614, 616, 618, and 619 for a second sub-set of input bits, a second destination sub-location, and the selected sub-set of weight bits. In this way, multiple sub-set of input values are processed in parallel. In at least one embodiment, these parallel operations are being performed for five sub-sets of input values, while reusing the sub-set of weight bits, along with five corresponding destination sub-locations.

In the foregoing description, certain specific details are set forth to provide a thorough understanding of various disclosed embodiments. However, one skilled in the relevant art will recognize that embodiments may be practiced without one or more of these specific details, or with other methods, components, materials, etc. In other instances, well-known structures associated with electronic and computing systems including client and server computing systems, as well as networks have not been shown or described in detail to avoid unnecessarily obscuring descriptions of the embodiments.

Unless the context requires otherwise, throughout the specification and claims which follow, the word “comprise” and variations thereof, such as, “comprises” and “comprising,” are to be construed in an open, inclusive sense, e.g., “including, but not limited to.”

The headings and Abstract of the Disclosure provided herein are for convenience only and do not limit or interpret the scope or meaning of the embodiments.

The various embodiments described above can be combined to provide further embodiments. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
receiving a destination-register location configured to store accumulation results, wherein the destination-register location includes a plurality of destination sub-locations;
receiving a source-register location configured to store a plurality of input bits;
receiving a weight-register location configured to store a plurality of weight bits, wherein a weight length of the plurality of weight bits is equal to an input length of the plurality of input bits;
copying, using the weight-register location, a sub-set of the plurality of weight bits a select plurality of number of times, wherein a size of the sub-set of weights is based on a filter index value; and
for each copy of the sub-set of weights:
selecting, using the source-register location, a sub-set of the plurality of input bits based on the size of the sub-set of weights, wherein the sub-set of input bits is shifted one bit from a previous sub-set of the plurality of input bits;
performing an XOR operation on each corresponding bit in the copy of the sub-set of weights with each corresponding bit in the selected sub-set of input bits; and
aggregating, in a corresponding destination sub-location of the plurality of destination sub-locations, an output of each XOR operation with each other and with a current value of the corresponding destination sub-location.

2. The method of claim 1, further comprising:
receiving the filter index value between 2 and 7.

3. The method of claim 1, further comprising:
receiving the filter index value of zero to indicate a fully connected layer.

4. The method of claim 1, wherein copying the sub-set of the plurality of weight bits the select plurality of number of times comprises:
copying the sub-set of the plurality of weight bits five times.

5. The method of claim 1, further comprising:
for each copy of the sub-set of weights:
performing a one's count operation on an output from the XOR operations on each corresponding bit in the copy of the sub-set of weights with each corresponding bit in the selected sub-set of input bits.

6. The method of claim 1, further comprising:
performing an XOR operation on each corresponding remaining bit in the plurality of weights with each corresponding remaining bit in the input bits;
performing a one's count operation on an output from the XOR operation on each corresponding remaining bit in the plurality of weights with each corresponding remaining bit in the input bits; and
adding the output of the one's count operation with another output from another one's count operation performed on an output from the XOR operation of each corresponding bit in a first copy of the sub-set of weights with each corresponding bit in the a first selected sub-set of input bits.

7. The method of claim 6, further comprising:
for each copy of the sub-set of weights:
performing a one's count operation on an output from the XOR operations on each corresponding bit in the copy of the sub-set of weights with each corresponding bit in the selected sub-set of input bits;
generating a filtered output by concatenating outputs from the one's count operations for each copy of the sub-set of weights;
performing an XOR operation on each corresponding remaining bit in the plurality of weights with each corresponding remaining bit in the input bits;
performing a one's count operation on an output from the XOR operation on each corresponding remaining bit in the plurality of weights with each corresponding remaining bit in the input bits;
generating a fully connected output by adding the output of the one's count operation with another output from another one's count operation performed on an output from the XOR operation of each corresponding bit in a first copy of the sub-set of weights with each corresponding bit in the a first selected sub-set of input bits;
selecting a final result between the filtered output and the fully connected output based on the filter index value; and
combining the final result with a current value stored at the destination-register location.

8. A system, comprising:
a memory that stores:
a destination register configured to store accumulation results, wherein the destination-register includes a plurality of sub-destinations;
a source register configured to store a plurality of input bits;
a weight register configured to store a plurality of weight bits, wherein a weight length of the plurality of weight bits is equal to an input length of the plurality of input bits;
a microprocessor coupled to the memory, wherein the microprocessor, in operation:
copies a sub-set of the plurality of weight bits in the weight register a select plurality of number of times, wherein a size of the sub-set of weights is based on a filter index value; and
for each copy of the sub-set of weights:
selects a sub-set of the plurality of input bits from the source register based on the size of the sub-set of weights, wherein the sub-set of input bits is shifted one bit from a previous sub-set of the plurality of input bits;
performs an XOR operation on each corresponding bit in the copy of the sub-set of weights with each corresponding bit in the selected sub-set of input bits; and
aggregates, in a corresponding sub-destination of the plurality of sub-destinations in the destination register, an output of each XOR operation with each other and with a current value of the corresponding sub-destination.

9. The system of claim 8, wherein the microprocessor, in further operation:
receives the filter index value between 2 and 7.

10. The system of claim 8, wherein the microprocessor, in further operation:
receives the filter index value of zero to indicate a fully connected layer.

11. The system of claim 8, wherein the microprocessor, in further operation:
copies the sub-set of the plurality of weight bits five times.

12. The system of claim 8, wherein the microprocessor, in further operation:
for each copy of the sub-set of weights:
performs a one's count operation on an output from the XOR operations on each corresponding bit in the copy of the sub-set of weights with each corresponding bit in the selected sub-set of input bits.

13. The system of claim 8, wherein the microprocessor, in further operation:
performs an XOR operation on each corresponding remaining bit in the plurality of weights with each corresponding remaining bit in the input bits;
performs a one's count operation on an output from the XOR operation on each corresponding remaining bit in the plurality of weights with each corresponding remaining bit in the input bits; and
adds the output of the one's count operation with another output from another one's count operation performed on an output from the XOR operation of each corresponding bit in a first copy of the sub-set of weights with each corresponding bit in the a first selected sub-set of input bits.

14. The system of claim 13, wherein the microprocessor, in further operation:
for each copy of the sub-set of weights:
performs a one's count operation on an output from the XOR operations on each corresponding bit in the copy of the sub-set of weights with each corresponding bit in the selected sub-set of input bits;
generates a filtered output by concatenating outputs from the one's count operations for each copy of the sub-set of weights;
performs an XOR operation on each corresponding remaining bit in the plurality of weights with each corresponding remaining bit in the input bits;
performs a one's count operation on an output from the XOR operation on each corresponding remaining bit in the plurality of weights with each corresponding remaining bit in the input bits;
generates a fully connected output by adding the output of the one's count operation with another output from another one's count operation performed on an output from the XOR operation of each corresponding bit in a first copy of the sub-set of weights with each corresponding bit in the a first selected sub-set of input bits;
selects a final result between the filtered output and the fully connected output based on the filter index value; and
combines the final result with a current value stored at the destination register.

15. A non-transitory computer-readable medium having contents that configure a microcontroller to perform a method, the method comprising:
receiving a destination-register location configured to store accumulation results, wherein the destination-register location includes a plurality of destination sub-locations;
receiving a source-register location configured to store a plurality of input bits;
receiving a weight-register location configured to store a plurality of weight bits, wherein a weight length of the plurality of weight bits is equal to an input length of the plurality of input bits;
copying, using the weight-register location, a sub-set of the plurality of weight bits a select plurality of number of times, wherein a size of the sub-set of weights is based on a filter index value; and
for each copy of the sub-set of weights:
selecting, using the source-register location, a sub-set of the plurality of input bits based on the size of the sub-set of weights, wherein the sub-set of input bits is shifted one bit from a previous sub-set of the plurality of input bits;
performing an XOR operation on each corresponding bit in the copy of the sub-set of weights with each corresponding bit in the selected sub-set of input bits; and
aggregating, in a corresponding destination sub-location of the plurality of destination sub-locations, an output of each XOR operation with each other and with a current value of the corresponding destination sub-location.

16. The non-transitory computer-readable medium of claim 15, wherein receiving the filter index value comprises:
receiving the filter index value between 2 and 7.

17. The non-transitory computer-readable medium of claim 15, wherein receiving a filter index value comprises:
receiving the filter index value of zero to indicate a fully connected layer.

18. The non-transitory computer-readable medium of claim 15, wherein copying the sub-set of the plurality of weight bits the select plurality of number of times comprises:
copying the sub-set of the plurality of weight bits five times.

19. The non-transitory computer-readable medium of claim 15, further comprising:
for each copy of the sub-set of weights:
performing a one's count operation on an output from the XOR operations on each corresponding bit in the copy of the sub-set of weights with each corresponding bit in the selected sub-set of input bits.

20. The non-transitory computer-readable medium of claim 15, further comprising:
performing an XOR operation on each corresponding remaining bit in the plurality of weights with each corresponding remaining bit in the input bits;
performing a one's count operation on an output from the XOR operation on each corresponding remaining bit in the plurality of weights with each corresponding remaining bit in the input bits; and
adding the output of the one's count operation with another output from another one's count operation performed on an output from the XOR operation of each corresponding bit in a first copy of the sub-set of weights with each corresponding bit in the a first selected sub-set of input bits.
